(19) United States
(12) Patent Application Publication
(10) Pub. No.: US 2004/0228424 A1
(43) Pub. Date: Nov. 18, 2004

(54) Receiver with analog barker detector

(76) Inventors: Keith R. Baldwin, Melbourne Beach, FL (US); Kantilal Bacrania, Palm Bay, FL (US); David J. Hedberg, Menlo Park, CA (US)

Correspondence Address: LAW OFFICES OF GARY R. STANFORD, 330 W OVERLOOK MOUNTAIN RD, BUDA, TX, 78610, US

(21) Appl. No.: 10/789,297

(22) Filed: Feb. 27, 2004

Related U.S. Application Data
(60) Provisional application No. 60/450,287, filed on Feb. 27, 2003.

(51) Int. Cl. H04B 1/69

(52) U.S. Cl. 375/343

(57) ABSTRACT

A receiver including an analog Barker detector including digital processing logic, a radio and an analog-to-digital converter (ADC). The digital processing logic has a receive signal input for processing digital baseband signals and a power activation input for receiving a detection signal. The radio receives and converts radio frequency (RF) signals into analog baseband signals, and includes a Barker matched filter coupled to receive the analog baseband signals, an envelope detector, a peak detector, and a counter circuit. The counter circuit detects Barker signals and provides the detection signal for powering up the digital processing logic. The digital processing logic is powered down between signal acquisitions to conserve power and powers up in response to the detection signal. The ADC may also be powered up and down in a similar manner to conserve additional power.

### CROSS-REFERENCE TO RELATED APPLICATIONS

This application claims the benefit of U.S. Provisional Application No. 60/450,287, filed on Feb. 27, 2003, which is herein incorporated by reference for all intents and purposes.

### BACKGROUND OF THE INVENTION

1. Field of the Invention

The present invention relates to wireless transceiver systems, and more particularly to an analog Barker detector that detects Barker signals in a wireless medium which may be used to enable significant power savings.

2. Description of the Related Art

Power consumption is a critical factor in wireless communications, including wireless local area networks (WLANs) implemented according to the IEEE 802.11 standard. A significant amount of power is consumed in the digital processing circuitry, which has been conventionally used to detect a valid signal in a wireless medium. Another power consuming device includes the analog-to-digital converters (ADCs) used to convert analog baseband signals from the radio to digital baseband signals used by the digital processing circuitry. In conventional designs, the ADCs and the digital processing circuitry could not be powered down since they performed vital signal detection functions.

It is desired to conserve power in wireless devices, including direct conversion devices which directly convert RF signals to baseband. Direct conversion or ZIF architectures pose additional challenges in handling the significant DC levels initially incorporated in the analog baseband signals provided from the radio's down-converter.

### SUMMARY OF THE INVENTION

A receiver including an analog Barker detector according to an embodiment of the present invention includes a radio with an analog Barker detector, an analog-to-digital converter (ADC), and digital processing logic. The radio receives and converts radio frequency (RF) signals into the analog baseband signals, and includes a Barker matched filter coupled to receive the analog baseband signals, an envelope detector coupled to the Barker matched filter, a peak detector coupled to the envelope detector, and a counter circuit coupled to the peak detector. The counter circuit detects Barker signals in the analog signal and provides the detection signal for powering up the digital processing logic. The ADC converts the analog baseband signals into the digital baseband signals. The digital processing logic is powered down between signal acquisitions and includes a power activation input for receiving the detection signal used to power up the digital processing logic.

The digital processing logic is powered down between signal acquisitions to conserve power and powers up in response to the detection signal. The ADC may also include a power activation input receiving the detection signal, where the ADC is powered down between signal acquisitions to conserve additional power and powers up in response to the detection signal. In one embodiment, the radio performs direct conversion and further includes first order DC correction loops using up/down counters as feedback integrators.

In an exemplary embodiment, the Barker matched filter includes a track and hold (T/H) stage and a Barker correlator. The T/H stage may include a sample circuit that samples the analog baseband signals and that provides corresponding voltage samples, a converter that converts each voltage sample to a sample current, and multiple matched current generator stages that convert each sample current into matched AC currents. The matched current generator stages may each include a current mirror and a slaved current source.

The Barker correlator may include multiple analog multiply-accumulate (MAC) cells and a switched-capacitor (S-C charge summer and reset circuit. The MAC cells are coupled to the T/H stage and collectively perform parallel Barker matched filtering in overlapped filter windows. The S-C charge summer and reset circuit has an input coupled to the Barker correlator and an output coupled to the envelope detector. Each analog MAC cell may include capacitors and switches that accumulate weighted current samples over a predetermined filter cycle. The envelope detector may include track and latch comparators, decode logic and a switched-capacitor charge redistribution summing amplifier.

The peak detector averages Barker correlator filter output samples, derives a dynamic threshold value, and compares the dynamic threshold value with Barker correlator filter output samples. The peak detector may include a low pass filter (LPF) and a comparator. The LPF averages envelope output samples and provides a threshold signal, and the comparator compares the threshold signal with the envelope output samples. In one embodiment, the LPF incorporates selectable bandwidth and is initially set in a high bandwidth mode during initial acquisition and re-acquisition of noise floor. The LPF is switched to a low bandwidth mode for tracking and signal detection. The LPF may further incorporate a quench mode during which a previously unknown signal state is erased and re-initialized to an expected noise floor value.

In one embodiment, the counter circuit includes two counters that are each reset periodically in a staggered fashion for overlapping windows and an OR circuit coupled to outputs of the two counters. In an alternative embodiment, the counter circuit includes multiple overlapped window counters coupled in parallel with multiple outputs, and decision logic receiving the multiple outputs for generating the detection signal. The overlapped window counters may be organized into a pair of parallel enabled banks, each bank including multiple staggered counters, and each bank reset by approximately half a predetermined detection interval.

### BRIEF DESCRIPTION OF THE DRAWING(S)

The benefits, features, and advantages of the present invention will become better understood with regard to the following description and accompanying drawings in which:

FIG. 1 is a block diagram of applicable portions of a WLAN transceiver with an analog Barker detector implemented according to an embodiment of the present invention;

FIG. 2 is a more detailed block diagram of an exemplary embodiment of the analog Barker detector of FIG. 1 implemented as an S-C analog Barker correlator detector block;

FIG. 3 is a block diagram of a data-shift, weight, and sum correlator FIR filter that may be used to implement each of the Barker matched filters of FIG. 2;

FIG. 4 is a block diagram of an exemplary Barker matched filter that realizes the computational form of equation 1, which implements either or both of the Barker matched filters of FIG. 2;

FIG. 5 is a more detailed block diagram of an exemplary embodiment of each T/H stage and S/H cell of FIG. 4;

FIG. 6 is a block diagram of another switched-capacitor circuit illustrating an alternative computational structure for implementing the Barker matched filters of FIG. 2;

FIG. 7 is a switched-capacitor circuit implemented according to an alternative embodiment of the present invention for implementing an input portion of the Barker matched filters of FIG. 2;

FIG. 8 is a more detailed schematic of an exemplary configuration of each of the analog MAC cells of FIG. 2;

FIG. 9 is a more detailed schematic diagram of an exemplary embodiment of the Barker matched filter correlator of FIG. 3 including the barker matched filter comprising the MAC cells coupled to the Barker weight and readout logic and further illustrating a more detailed schematic diagram of the S-C charge summer and reset circuit of FIG. 2;

FIG. 10 is a more detailed schematic diagram of the envelope detector of FIG. 2 implemented as an S-C envelope approximation circuit;

FIG. 11 is a more detailed schematic and block diagram of an exemplary embodiment of the Barker correlation peak detector and the counter circuit of FIG. 2;

FIG. 12 is a more detailed schematic diagram of an exemplary embodiment of the LPF of FIG. 11 implemented as a first-order S-C LPF circuit;

FIG. 13 is a graph diagram showing characteristics of the envelope samples in the presence of noise-only compared with the case of a Barker signal present at 0 dB SNR relative to a typical CFAR threshold setting;

FIG. 14 is a graph diagram illustrating envelope comparisons when a weak Barker preamble is present with power equal to the noise (i.e. SNR=0 dB) relative to the CFAR threshold setting;

FIG. 15 is a graph diagram showing the sensitivity of false alarm probability and missed detection probability with variations in the threshold value with no multipath distortion;

FIG. 16 is a timing diagram of the acquisition time line for a normal weak signal packet onset when the transceiver of FIG. 1 is tracking at the noise floor;

FIG. 17 is a timing diagram of the acquisition time line for the strong signal case;

FIGS. 18 and 19 show time domain correlator magnitude waveforms for a case where the RMS delay spread is 250 ns and SNR=0 dB (FIG. 19) compared to the same SNR with no multipath (FIG. 18);

FIG. 20 is a block diagram illustrating a three sample moving average FIR filter coupled at the output of the envelope detector of FIG. 2 for receiving the ES signals and providing ES′ signals to the peak detector of FIG. 2;

FIG. 21 is a figurative diagram illustrating sliding window peak counting; and

FIG. 22 is a block diagram of an exemplary embodiment of an analog Barker detector including a counter circuit employing a sliding window counting algorithm.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

An analog Barker-preamble detector according to embodiments of the present invention may be employed as a power saving device for 802.11 Wireless Local Area Network (WLAN) transceiver systems, including those implemented according to 802.11b. In the illustrated embodiment, a WLAN transceiver system is partitioned as a separate radio transceiver Integrated Circuit (IC) component and a digital baseband processor (BBP)/Media Access Control (MAC) IC component. These two ICs are connected through a low pin-count high-speed digital interface. The present invention applies to any system configuration and also applies to other radio architectures.

In accordance with an exemplary embodiment of the present invention, the mixed signal transceiver includes a low-power, analog-based Barker preamble detector circuit that operates directly on the analog I and Q baseband signals from the RF down converter, without the assistance of I and Q analog to digital converters (ADCs) or BBP functions. In order to conserve power, at least the I and Q ADCs and the BBP signal detection functions are powered down. Thus, until a valid 802.11b Barker preamble or sufficient signal energy in the channel is detected by the analog circuitry, the ADCs, high-speed digital radio interfaces, and the baseband processing circuits remain powered off. While in this Barker “signal scan” mode, the transceiver IC also implements DC offset tracking and gain tracking functions used for accurate detection, but with significantly reduced power over the normal digital signal processing. Power consumption for the analog Barker signal scan mode, using an analog Barker preamble detector according to an embodiment of the present invention, is only a few milliwatts (mW). This power is an order of magnitude less than the power consumed by the analog to digital conversion and digital processing presently used for the detection processing in existing WLAN systems. The ability to power down the higher powered devices until a valid packet is detected in the wireless medium enables extended battery charge during long periods of low duty cycle radio usage.

The low-power Barker preamble detector does not compromise range capability. The signal scan processing is capable of performing a full Barker matched-filter de-correlation and making reliable signal onset detections for weak signals of 0 decibel (dB) signal-to-noise ratio (SNR). The performance of the low-power analog Barker preamble detector is roughly equivalent to that obtained with optimized digital baseband processing, so that low power signals are detected and acquired even while digital processing is powered down or in standby mode conserving power consumption.

Once signal onset is detected by the analog Barker preamble detector, analog to digital converters and robust digital signal detection logic are powered up, and the Automatic Gain Control (AGC) processing and subsequent acquisition processing is handed over to the digital baseband processor, which then proceeds similarly as in present implementations. For example, upon signal detection, the analog system asserts a control signal or the like to power up or otherwise start digital processing. When the Media Access Control timing has determined end of packet reception and the radio channel is expected to be quiet for a sufficient period of time, the control is handed back to the transceiver incorporating the analog Barker detector which runs with lower power consumption. The analog Barker detector immediately re-acquires and tracks the noise floor and then reverts to the low-power signal scan mode in which the ADCs and baseband digital processing are powered down once again. The low-power analog Barker detector in signal-scan mode operates with either long or short 802.11b preamble modes.

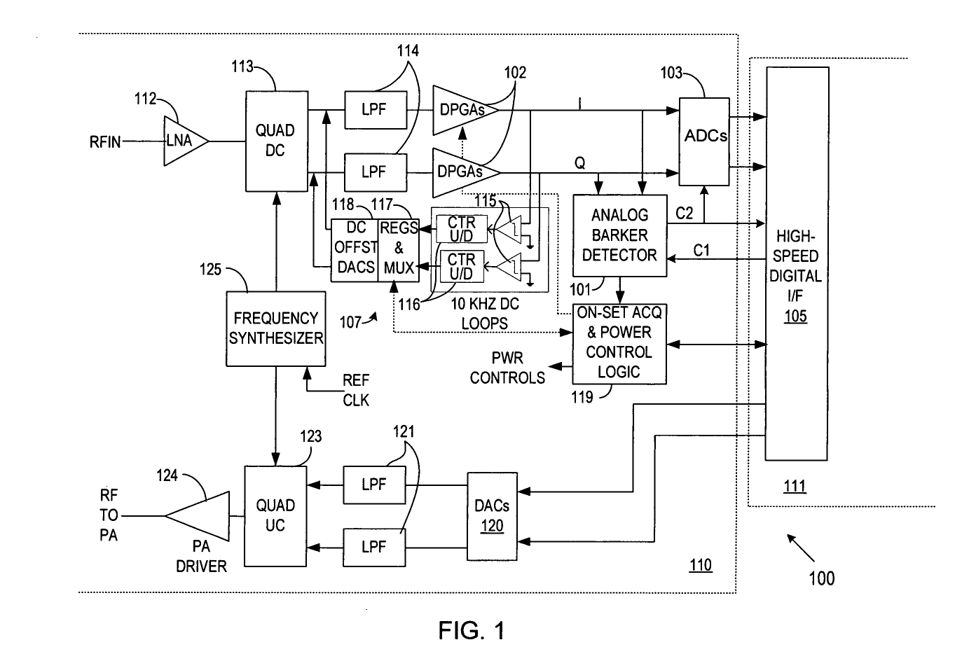

FIG. 1 is a block diagram of applicable portions of a WLAN transceiver 100 with an analog Barker detector 101 implemented according to an embodiment of the present invention. The WLAN transceiver 100 includes a radio transceiver 110 coupled to a BBP/MAC 111 via a high speed interface. Only applicable portions of the radio transceiver 110 and BBP/MAC 111 are shown, and each may be implemented on a separate IC. The WLAN transceiver 100 is configured as a direct conversion receiver architecture in which a received RF signal RFIN from the radio antenna (not shown) is directly down converted to baseband without using intermediate frequency devices (e.g., a zero intermediate frequency or ZIF configuration). In the direct conversion architecture, baseband DC correction is a primary concern when processing weak signals near the noise floor. Between packet receptions in the analog signal scan mode, the transceiver 100 detects relatively small signals that contain the Barker preamble modulation, and thus DC offset variations can easily dominate the signal dynamic range.

The RFIN signal is provided through a low noise amplifier (LNA) 112 to a quadrature down-converter 113, which down-converts the RFIN radio signal to baseband (BB) and which splits the BB signal into an in-phase (I) and a quadrature phase (Q) signal. The I and Q signals are separately filtered through a pair of low pass filters (LPFs) 114 and amplified by BB AGC amplifiers 102, and then provided to corresponding ADCs 103 for conversion to digital format. The I and Q digital signals are then provided to a high-speed digital interface 105 of the BBP/MAC 111. For transmission, digital I and Q signals output from the interface 105 are provided to corresponding digital-to-analog converters (DACs) 120, which forward analog I and Q signals to LPFs 121 and then to a quadrature up-converter 123. The up-converter 123 integrates and up converts the I and Q signals into an RF signal, which is amplified by a power amplifier (PA) driver 124 for transmission via the antenna. The transmission portion is not further described. A frequency synthesizer 125 receives a reference clock signal REF CLK and generates the clock signals used by the converters 113, 123. The ADCs 103 and the DACs 120 are shown implemented on the radio transceiver 110, although either or both may be implemented on the BBP/MAC 111 or implemented separately.

DC rejection is accomplished by a direct DC first order cancellation tracking loop 107 that measures and subtracts DC via a pair of adders 126 at the outputs of the down-converter 113. The received analog I and Q signals are separately provided to a pair of comparators 115, which output binary signals to a pair of up/down (U/D) counters 116. The outputs of the counters 116 are provided to register and multiplexer logic 117 and DC offset DACs 118. The outputs of the DC offset DACs 118 are subtracted from the I and Q outputs of the down-converter 113 by the adders 126 to subtract measured DC levels. The DC correction loops 107 operate as feedback integrators to keep the DC of the BB signals low enough at the baseband input path to avoid saturation when sufficient baseband gain is applied to process the pass-band noise and signals. Baseband path gain is set to a fixed high-gain level during the analog signal scan mode where power is optimized. When entering this initial noise-floor tracking mode, the BBP/MAC 111 provides a DC offset correction level determined from previous packet processing via on-set acquisition and power control logic 119 provided on the radio transceiver 110.

The logic 119 sets the initial values in the registers of the logic 117, either from an initial default value or provided from the BBP/MAC 111, and the signal scan feedback DC loops 107 continue tracking during signal onset. The logic 119 also controls the gain of the amplifiers 102. Similarly when the analog Barker detector 101 detects a signal and transitions the transceiver 100 into full baseband processing, the new DC offset levels determined during the signal scan mode are handed over by the logic 119 to the BBP/MAC 111 as the initial conditions for subsequent digital preamble/packet processing. In one embodiment, the local integrator based DC offset loops 107 have a tracking bandwidth of several kilohertz (KHz) (e.g., 10 KHz) sufficient to take out major DC variations caused by receiver movement and thermal effects.

Beyond the first level of DC tracking, the analog I and Q signals are monitored by the analog Barker detector 101 for signal detection. In exemplary embodiments, the analog Barker detector 101 incorporates switched-capacitor (S-C) Barker correlator circuits which implement high pass filtering to reject residual short term DC variations and additional static DC offsets in Barker sampling circuits. As further described below, exemplary embodiments of the analog Barker detector 101 include I and Q track and hold (T/H) current generator circuits, which include an offset feedback loop with bandwidth on the order of 50 KHz to 100 KHz. This acts as a high pass pre-detection filter, eliminating most remaining DC effects. There may still be some DC offset/drift produced by the analog barker detector 101. The residual offset, however, is attenuated to an adequate level by the DC-spreading effect of the Barker matched filter. The BBP/MAC 111 provides a control signal C1 that enables and disables the analog Barker signal scan mode. When enabled, control signals C2 are provided from the analog Barker detector 101 to the ADCs 103 and the interface 105 to power up and down and initialize appropriate parts of the transceiver 100 used in the analog signal scan mode or otherwise in the packet active mode. The C2 signals are asserted when a packet is detected in the wireless medium to power up the ADCs 103 and the BBP/MAC 111. The ADCs 103 and the BBP/MAC 111 power up to begin acquisition of the detected signal.

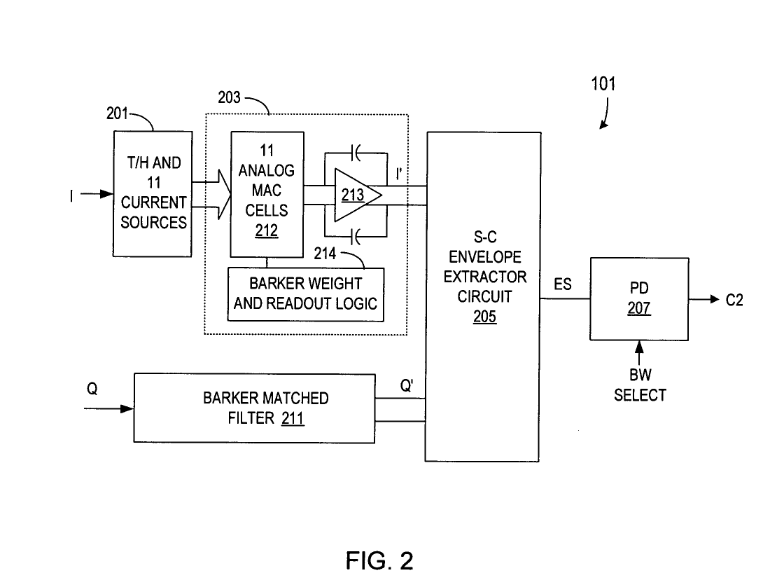

FIG. 2 is a more detailed block diagram of an exemplary embodiment of the analog Barker detector 101 implemented as an S-C analog Barker correlator detector block. The analog Barker detector 101 includes two Barker matched filters 210 and 211 that receive the analog I and Q signals, respectively. Only the Barker matched filter 210 is shown in further detail, where it is understood that the Barker matched filter 211 is implemented in a substantially identical manner. The Barker matched filter 210 includes a track and hold (T/H) stage 201 followed by a Barker matched filter correlator 203. The correlator 203 shown includes a Barker matched filter including 11 multiply-accumulators (MACs) 212 having an input coupled to the T/H stage 201 and another input coupled to Barker weight and readout logic 214 which provides Barker coefficients or weight factors. The MACs 212 have an output coupled to an input of an S-C charge summer and reset circuit 213. The outputs of the Barker matched filters 210 and 211, shown as I′ and Q′ output sample vector signals, are provided to an S-C envelope extractor circuit (envelope detector) 205, which approximates magnitude of the I′ and Q′ signals. The envelope output signal ES of the envelope detector 205 are provided to a correlation peak detector (PD) 207, which outputs a signal detect signal SD. The SD signal is provided to a counter circuit 209, which generates the C2 signals.

The peak detector 207 averages Barker correlator filter output samples from the envelope detector 205, derives a dynamic threshold value used for peak detection comparisons, and generates the SD signal at its output. As described further below, this is a constant false alarm rate (CFAR) type of signal detector function.

In operation, when a signal occurs in the channel, the detected filter output rises based on the step change in average signal power. Any size signal may be received, depending on proximity of the transmitter. A threshold signal increase level is defined to initiate the detection process. Larger signals cause immediate detection, and possible saturation of the detection path, regardless of the type of signal present. Signal detection transitions the transceiver 100 into a full baseband acquisition mode until the wireless channel is clear again between packets. The analog Barker detector 101 fully recovers from a possible saturated state even with short SIFS, and re-acquires the noise floor threshold level within a few microseconds for analog signal scanning. This non-Barker strong-signal detection behavior is also useful in detecting non-Barker signals such as the 802.11g WLAN waveform. In the 802.11g case, upon signal detection, the robust digital processing has the opportunity to detect and receive the 802.11g waveform from the low power scan state.

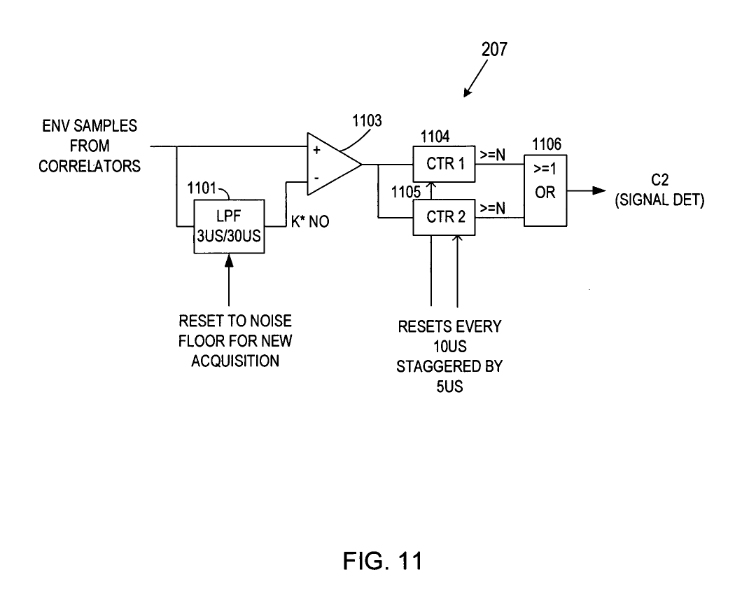

In the embodiment shown, the PD 207 includes a low pass filter (LPF) 1101 (FIG. 11) with two selectable bandwidth modes that are switched seamlessly based on a bandwidth select signal BW SEL. In addition, since the LPF 1101 can be saturated on larger signals during detection, its state is capable of being reset for rapid and predictable re-acquisition of the noise floor level after the packet has passed through. A “quench” mode is also employed to discharge the LPF 1101 from excessively large values. A fast high bandwidth filter mode is used to re-acquire the noise level quickly. A higher bandwidth, however, adds too much variation to the dynamic threshold, contributing to higher than desired false alarm rates. Therefore, after re-acquiring the noise floor level, the LPF 1101 switches to a lower bandwidth mode that reduces variation and holds the threshold level during signal onset detection. The bandwidth switching does not introduce transients that cause false alarms.

The analog Barker detector 101 employs various new functions in the control interface between the radio transceiver 110 and the BBP/MAC 111. The BBP/MAC 111 provides the C1 signal to enable and disable the analog Barker signal scan mode. The disable mode quenches the LPF 1101 of the PD 207. The C2 signals are provided from the analog Barker detector 101 to power up and down and initialize appropriate parts of the transceiver 100 used in the analog signal scan mode or otherwise in the packet active mode (e.g. ADCs, high speed digital clock and interface circuits, etc.). Handover control and data functions for the DC offset tracking loops are provided that allow the current DAC offset values to freeze upon signal onset detection. The DAC offset values are subsequently updated by the BBP/MAC 111. Similarly, the DC offset registers 117 are left in the correct state by the BBP/MAC 111 via the control logic 119 once the digital interface 105 shuts down and analog signal scan mode is re-entered. The analog Barker detector 101 includes a timed control signal BW SELECT that selects the bandwidth mode of the LPF 1101 of the PD 207. The high bandwidth mode is enabled immediately upon onset-detection and not switched back to low bandwidth until sufficient time has occurred to ensure re-acquisition of the analog Barker detector noise floor after quenching. The detector count thresholds are programmable to ensure flexibility for unknown signal conditions and false alarm characteristics. The analog signal scan mode of operation may be completely bypassed, where preamble detection is implemented in a conventional manner through the BBP/MAC 111.

In alternative embodiments, there are other power management control functions at the individual circuit level that set the performance level of various circuits during the low-power signal scan mode. For example, the voltage-controlled oscillator (VCO) phase noise, quadrature accuracy, and linearity of the down converter 113 do not need to be optimized for the detection mode, and current can be relaxed to obtain additional power savings.

In the embodiment shown, analog Barker detector 101 processes the analog I and Q samples at a rate of 22 mega symbols per second (Msps), which is the same as the ADC sampling rates for digital packet processing. Since the processed input signal is inherently noisy, the dynamic range and noise performance of these circuits is not critical, allowing small capacitors and lower op-amp currents than for other applications. This enables a low-power and area-efficient overall circuit implementation.

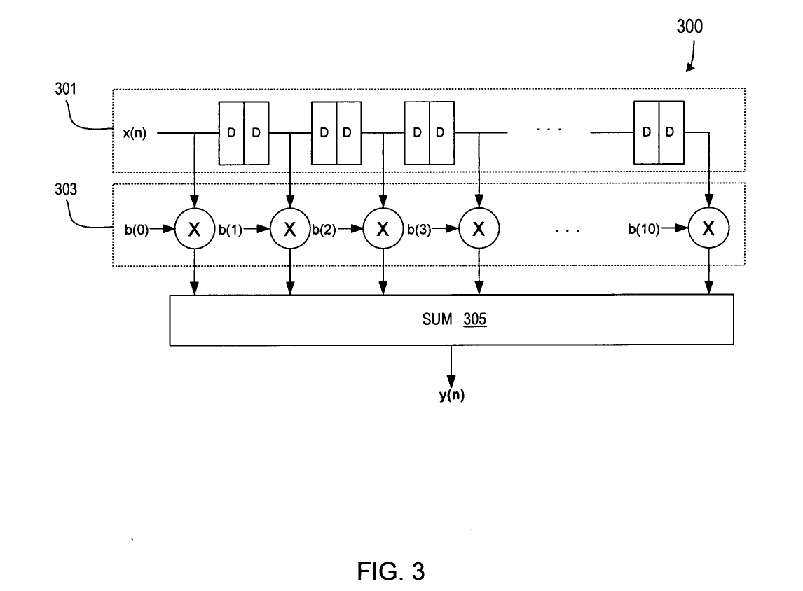

FIG. 3 is a block diagram of a data-shift, weight, and sum correlator FIR filter 300 that may be used to implement each of the Barker matched filters 210 and 211. The Barker correlation filter 300 performs the filter function as given by the following equation 1:

$$y ( n ) = {\sum }_{m = 0}^{N - 1} b ( m ) \cdot x ( n - 2 m )$$

where n=11, b=[1 1 −1 −1 −1 1 −1 −1 1 −1], x(n) are input samples of a selected one of the I and Q signals, and y(n) are output samples provided to the envelope detector 205. In this case, a set of data shift registers 301 receive the input samples x(n), where the registers 301 provide 11 shifted output values to corresponding inputs of a set of combiners 303. Each combiner (or multiplier) receives a corresponding one of a set of Barker coefficients b(m), and provides an output to a summing circuit 305 generating the output signal y(n).

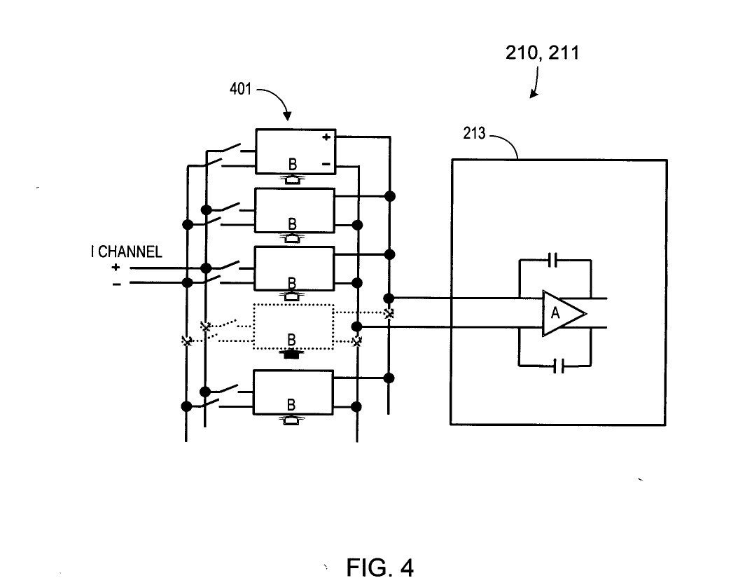

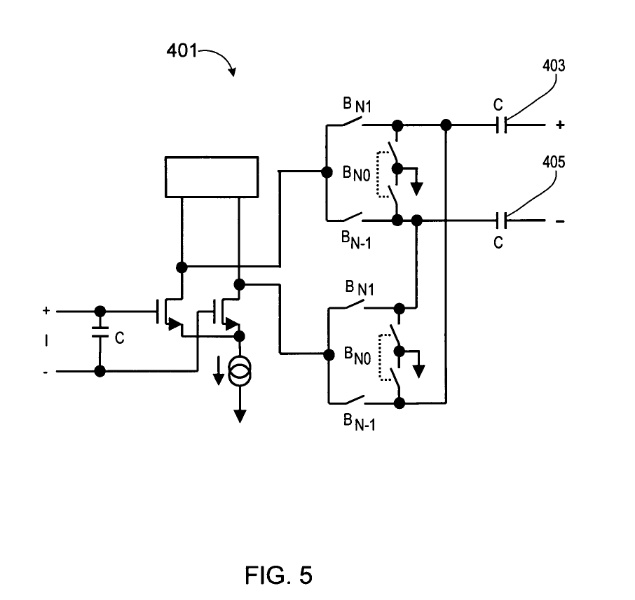

FIG. 4 is a block diagram of an exemplary Barker matched filter 400 that realizes the computational form of equation 1, which implements either or both of the Barker matched filters 210 and 211. The Barker matched filter 400 uses a switched-capacitor circuit utilizing a bank of sample-and-hold circuits operating in a rotating buffer configuration. The Barker matched filter 400 includes a set of input switches 401 representing the T/H stage 201 and 22 sample and hold (S/H) cells 403, each having a “B” input receiving a Barker weight from the Barker weight and readout logic 214. The outputs of the cells 403 are provided to the S-C charge summer and reset circuit 213. FIG. 5 is a more detailed block diagram of an exemplary embodiment of each T/H stage 401 and S/H cell 403. For this implementation, incoming samples are stored in a rotating buffer configured with 22 analog S/H cells. The input samples are converted to charge stored on either a positive capacitor 503 or a negative capacitor 505, depending on the weighting of the Barker coefficient sequence. Then the appropriate 11 Barker-weighted capacitors in the array are selected and summed together by the switched-capacitor summing amplifier 213.

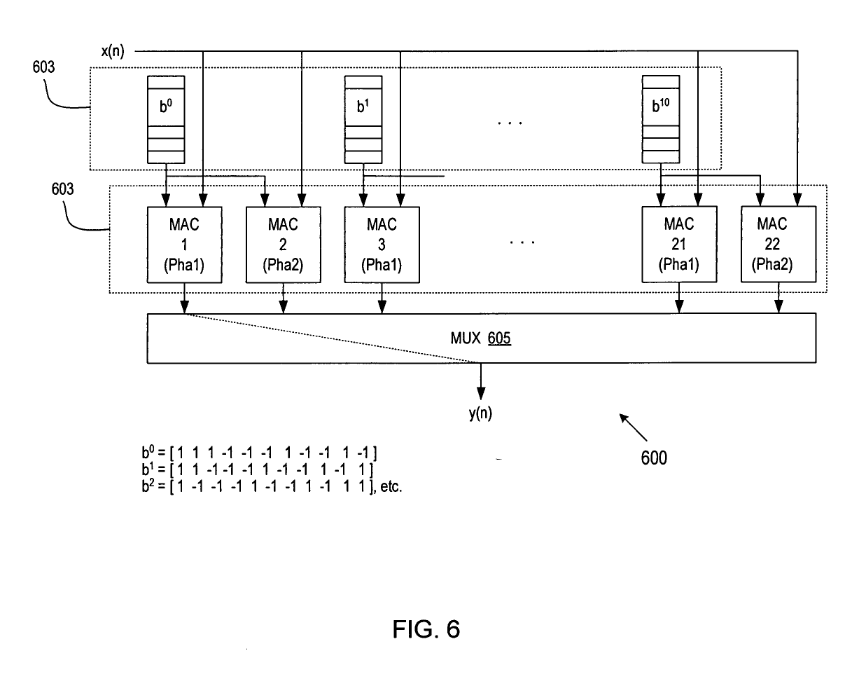

FIG. 6 is a block diagram of another switched-capacitor circuit 600 illustrating an alternative computational structure for implementing the Barker matched filters 210 and 211. The circuit 600 uses 22 multiply-accumulators (MACs) 601 receiving the input signal x(n) and the Barker coefficients b(m) stored in memory devices 603. The outputs from the MACs 601 are provided to a multiplexer (MUX) 605. This structure performs the same Barker filter computation of equation 1 previously described. The Barker coefficients are b⁰=[1 1 1 −1 −1 −1 1 −1 −1 1 −1], b¹=[1 1 −1 −1 −1 1 −1 −1 1 −1 1], b²=[1 −1 −1 −1 1 −1 −1 1 −1 1 1], etc.

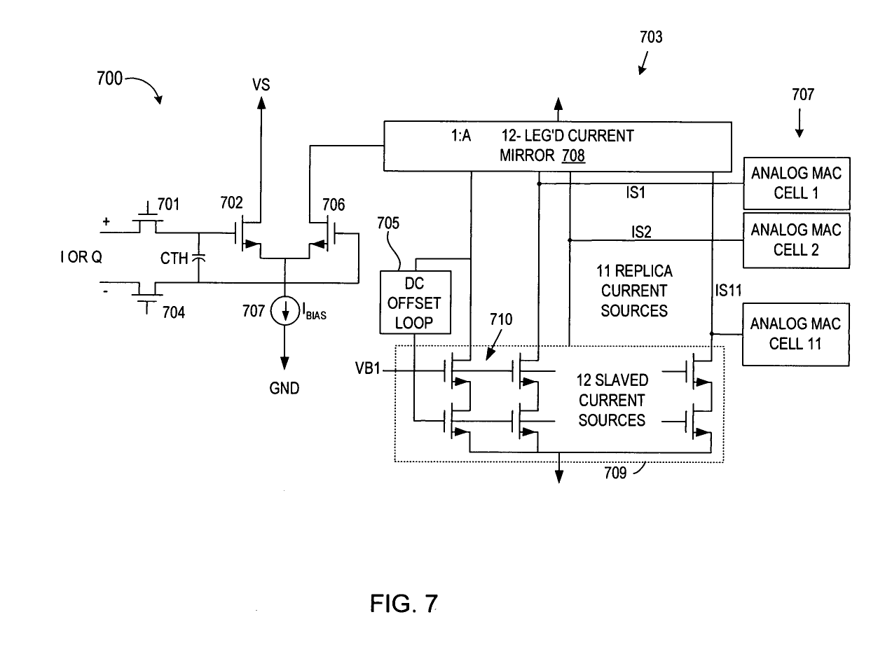

FIG. 7 is a switched-capacitor circuit 700 implemented according to an alternative embodiment of the present invention for implementing an input portion of the Barker matched filters 210 and 211 up to the MACs 212. The positive I or Q signal is applied via drain and source of a first FET 701 to one end of an input T/H capacitor CTH and to the gate of a FET 702. The negative counterpart I or Q signal is applied via drain and source of a second FET 704 to the other end of the capacitor CTH and to the gate of another FET 706 coupled relative to the FET 702 as a differential pair. In particular, the sources of the FETs 702, 706 are coupled together and to the input of a bias current sink 707 drawing a bias current IBIAS to ground (GND). The drain of the FET 702 is coupled to a voltage source signal VS and the drain of FET 706 is coupled to a 12-legged current mirror circuit 708. Each current mirror (not explicitly shown) in the current mirror circuit 708 is coupled to a counterpart slaved current source (not explicitly shown) in a current source circuit 709 via a bias line BL and 11 signal lines IS1-IS11. Each current source of circuit 709 includes a pair of FETs coupled in series between a counterpart signal line from the current mirror circuit 708 and ground. The 12 pairs of current mirrors and current sources form a set of 11 matched AC current sources 703, with a first set forming a bias current source 710. The gates of the upper FETs receive a bias voltage VB1 and the gates of the lower FETs are coupled to a DC offset loop 705. The DC offset loop 705 is also coupled to the drain of the upper FET of the bias current source 710 at bias line BL. Each signal line between the current mirror and current source circuits 708, 709 is coupled to a corresponding one of the 11 analog MAC cells 212.

The T/H and current generator stages (for I and Q channels) perform a sample and hold operation that also converts input voltage samples from the I and Q baseband outputs of the transceiver 100 to a current signal IS applied to the current mirror circuit 708 of the matched AC current sources 703. The DC blocking loop 705 ensures that the current sources pass the high-pass filtered component of the signals to the Barker correlation filters. This feedback loop removes DC offsets and tracks out short term level variations in each sampled current generator circuit. The loop bandwidth can be on the order of 100 KHz or more without effecting the detected signal characteristics. The overall detector performance relies on adequate matching and distortion characteristics in this inherently open-loop V-to-IS approach. A non-overlapped two-phase clock approach is employed. In one phase, the sample caps are charged by the source, and in the second phase, the resulting current samples are stable. The output current on the signal lines are provided to the analog MAC cells 212 that essentially perform parallel Barker matched filtering in overlapped filter windows. Each matched filter output sample is thus a Barker weighted accumulation of the input samples.

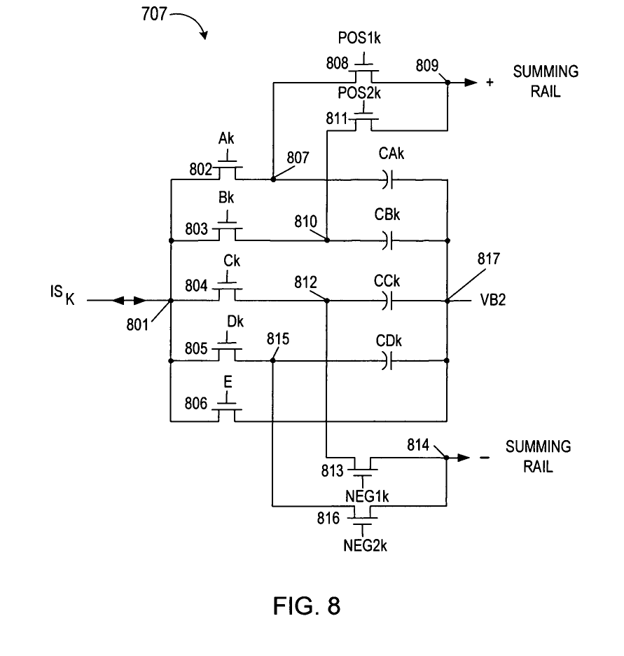

FIG. 8 is a more detailed schematic of an exemplary configuration of each of the analog MAC cells 212. An input current signal ISk (where “k” is an index from 1 to 11) is applied via node 801 through the drain-source of a FET 802 to a node 807, which is coupled through the drain-source of another FET 808 to a node 809 forming a positive summing rail. The node 801 is also coupled through the drain-source of a FET 803 to a node 810, which is coupled through the drain-source of another FET 811 to node 809. The node 801 is also coupled through the drain-source of a FET 804 to a node 812, which is coupled through the drain-source of another FET 813 to a node 814 forming a negative summing rail. The node 801 is also coupled through the drain-source of a FET 805 to a node 815, which is coupled through the drain-source of another FET 816 to node 814. The node 801 is also coupled through the drain-source of a FET 806 to a node 817 developing a bias voltage signal VB2. The node 817 is coupled to one end each of four capacitors CAk, CBk, CCk and CDk. The other side of capacitor CAk is coupled to node 807, the other side of capacitor CBk is coupled to node 810, other side of capacitor CCk is coupled to node 812, and other side of capacitor CDk is coupled to node 815. The FETs operate as switches, where FETs 802-806 have gates that receive switching signals Ak, Bk, Ck, Dk and E, respectively. The FETs 808 and 811 have gates that receive switching signals POS1k and POS2k, respectively. The FETs 813 and 816 have gates that receive switching signals NEG1k and NEG2k, respectively.

Each analog MAC cell 212 contains capacitors and switches that accumulate the weighted current samples over a filter interval of 22 clock cycles (1 microsecond). The positive Barker weighted samples are accumulated in one capacitor, and the negative weighted samples in a second capacitor. At the end of the filter accumulation, the two capacitor charges are subtracted to form the complete weighted filter. The sequencing of Barker weights determines the phase of the filter and is synchronized with the readout and reset period of the filter. Each analog MAC cell 212 contains four capacitors since the filter accumulations, described in the following equation 2, are performed on alternate samples:

$$y ( n ) = {\sum }_{m = 0}^{N - 1} b + ( m ) \cdot x ( n - 2 m ) - {\sum }_{m = 0}^{N - 1} b - ( m ) \cdot x ( n - 2 m ) \qquad ( 2 )$$

where b+=[1 1 1 0 0 0 1 0 0 1 0], and b−=[0 0 0 1 1 1 0 1 1 0 1]. Thus each MAC cell 212 supports two different filter accumulations, each with positive and negative parts. The switches determine to which capacitor or bias supply the current is directed on each sample cycle. The results of each filter accumulation are summed and read out at a rate of one filter per sample cycle.

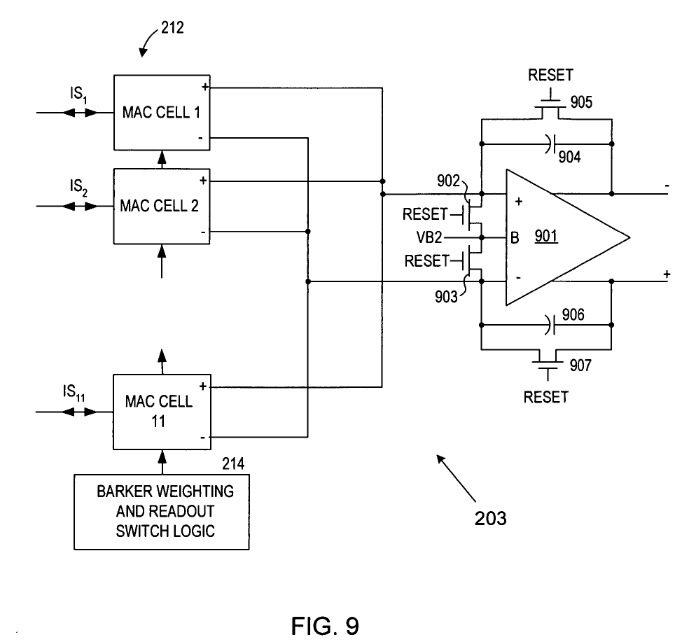

FIG. 9 is a more detailed schematic diagram of an exemplary embodiment of the Barker matched filter correlator 203 including the barker matched filter comprising the MAC cells 212 coupled to the Barker weight and readout logic 214, and further illustrating a more detailed schematic diagram of the S-C charge summer and reset circuit 213. Each MAC cell 212 includes positive and negative outputs provided to the non-inverting and inverting inputs, respectively, of the S-C charge summer and reset circuit 213. The S-C charge summer and reset circuit 213 includes first and second FET switches 902 and 903 coupled to the inputs of a differential amplifier 901. The first switch 902 has its drain and source coupled between the non-inverting and bias inputs of the amplifier 901 and second switch 903 has its drain and source coupled between the bias and inverting inputs of the amplifier 901. The bias input receives the VB2 signal. A capacitor 904 and the drain and source of a FET switch 905 are coupled in parallel and between the non-inverting input and the inverting output of the amplifier 901. Another capacitor 906 and the drain and source of another FET switch 907 are coupled in parallel and between the inverting input and the non-inverting output of the amplifier 901. The gate of each of the FET switches receives a signal RESET.

In this case, the correlator 203 includes readout switches and a differential charge redistribution summing amplifier that may be used to readout, subtract, and scale the accumulated filter results for subsequent detection processing. Since there are two Barker correlator matched filters (for both I and Q channels), there are 88 capacitors total in the MAC cell array 212 that are used for filter summing. These can be small capacitors.

Either form of matched filter correlator circuit (e.g., the Barker matched filter 400 or the switched-capacitor circuit 700) can be practically implemented. The chosen approach depends on detailed circuit level and design tradeoffs. The switched capacitor circuit 700 utilizes fewer overall capacitors in the array, since only one S/H capacitor is used each for I and Q filters. The number of current sources and switches is roughly the same for both configurations. Power consumption is similar.

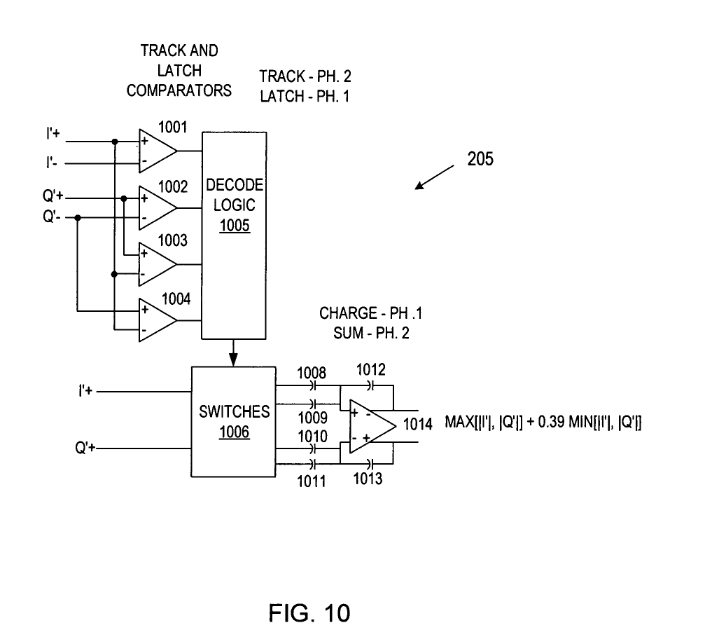

FIG. 10 is a more detailed schematic diagram of the envelope detector 205 implemented as an S-C envelope approximation circuit employed to derive the magnitude samples of the I′ and Q′ signals to provide the ES signal. The outputs of the quadrature matched filter correlators contain a magnitude and phase component. Only the magnitude component is desired for signal detection since the carrier phase of the preamble signal is unknown at this point. The differential matched filter outputs I′ and Q′ are each shown in differential form including I′+, I′−, Q′+ and Q′− signals, which are provided to a set of track and latch comparators 1001, 1002, 1003 and 1004. In particular, the I′+ signal is provided to the non-inverting input of the comparator 1001 and to the inverting inputs of the comparators 1003 and 1004. The I′− signal is provided to the inverting input of the comparator 1001. The Q′+ signal is provided to the non-inverting inputs of the comparators 1002 and 1003. The Q′− signal is provided to the inverting input of the comparator 1002 and to the non-inverting input of the comparator 1004. The outputs of the comparators 1001-1004 are provided to decode logic 1005, which has an output coupled to switches 1006 receiving the I′+ and Q′+ signals. The switches 1006 include a first pair of outputs each coupled to one end of a respective pair of capacitors 1008 and 1009, having their other ends coupled together and to the non-inverting input of a charge summing amplifier 1014 and to one end of a first feedback capacitor 1012. The switches 1006 include a second pair of outputs each coupled to one end of a respective pair of capacitors 1010 and 1011, having their other ends coupled together and to the inverting input of the amplifier 1014 and to one end of a second feedback capacitor 1013. The other end of the capacitor 1012 is coupled to the inverting output and the other end of the capacitor 1013 is coupled to the non-inverting output of the amplifier 1014. The amplifier 1014 outputs the ES signals.

In operation, the differential matched filter outputs I′ and Q′ are compared using the comparators 1001-1004 that compute the absolute sign and relative sizes of |I′| and |Q′| samples. Then the switched cap charge redistribution summing amplifier 1014 computes the classical envelope approximation given by the following equation 3:

max[|I′|, |Q′|]+0.39*min[|I′|, |Q′|] (3)

The weights to apply to the summation are determined by the four parallel comparator logic results at each sample cycle. The processing is efficiently pipelined as in other S-C circuit applications. The magnitude (envelope) samples are then processed for Barker correlation-peak detection, as further described below.

FIG. 11 is a more detailed schematic and block diagram of an exemplary embodiment of the Barker correlation peak detector 207 and the counter circuit 209. The ES envelope output signals from the S-C envelope detector 205 are provided to the non-inverting input of a comparator 1103 and to an input of the LPF 1101. The output of the LPF 1101 is provided to the inverting input of the comparator 1103. The output of the comparator 1103 generates the SD signal, which is provided to the inputs of a pair of counters 1104 and 1105, shown as CTR 1 and CTR 2, respectively, of the counter circuit 209. The outputs of the counters 1104, 1005 are provided to respective inputs of a 2-input OR-gate 1106, which outputs at least part of the C2 control signals. The LPF 1101 resets to the noise floor after one acquisition and before the next. In the configuration illustrated, the counters 1104 and 1105 each reset after a predetermined period, such as 10 microseconds (μs), and the resets are staggered by a predetermined amount with respect to each other, such as approximately 5 μs.

A primary objective of the peak detector 207 is to reliably discriminate between noise or weak non-Barker signals only and a weak Barker correlated preamble of similar power. The peak detector circuit 207 illustrated uses a threshold that is derived from the envelope sample levels in order to remove the effects of gain error that would plague any constant threshold approach. This is accomplished by averaging the envelope output samples ES with the LPF 1101, applying appropriate scaling (gain), and using this signal as the reference to the comparator 1103. The LPF 1101 has sufficient bandwidth to track variations in the noise floor power, but also has low enough bandwidth to ensure that the threshold does not change appreciably with preamble onset until the preamble is reliably detected. Since the threshold is proportional to signal power at this point, the gain uncertainties of the forward path circuits do not significantly impact the detection performance. The relatively simple form illustrated has been shown by simulation to work well down to a SNR=0 dB in the absence of significant multi-path signals.

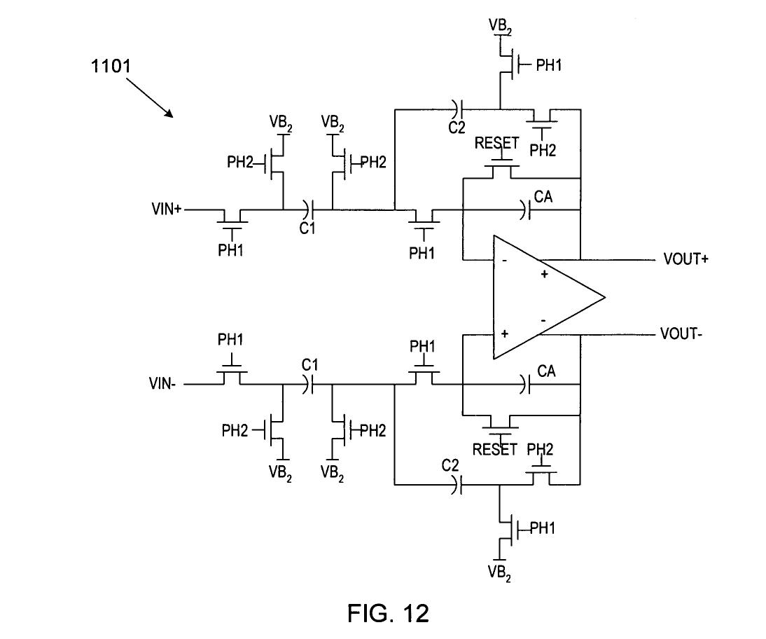

FIG. 12 is a more detailed schematic diagram of an exemplary embodiment of the LPF 1101, implemented as a first-order S-C LPF circuit. The LPF 1101 receives the differential ES signals and outputs differential VOUT+/− signals provided to the comparator 1103. In this exemplary embodiment, the programmable first-order IIR LPF 1101 is implemented with switched-capacitor circuits with similar 22 Msps timing as for the upstream circuits. During initial acquisition and re-acquisition of the noise floor reference level, the LPF 1101 is set for high bandwidth, such as, for example, using a time constant of approximately 2 to 3 μs, in order to quickly establish the approximate noise power level. Then the LPF 1101 is switched seamlessly to a lower bandwidth mode, such as, for example, using a time constant of approximately 30 μs, in order to allow tracking of the signal and noise floor with reduced variance. In addition, the filter implements the quench mode during which a previous unknown signal state is erased and re-initialized to a value close to that expected for the receiver noise floor. The quench mode allows the LPF 1101 to quickly reset and re-acquire between packets to the desired inter-packet noise floor. The LPF 1101 also has a DC voltage gain that is determined by a gain ratio of −C1/C2. The circuit illustrated has only one first order filter time constant that is determined by the ratios of the capacitors C1, C2, and CA. The capacitor CA essentially stores the state of the first order filter. In order to make the switching of filter time constants seamless, the charge on this capacitor remains constant through the switch.

Although not shown, a straightforward way to make the filter have two bandwidth settings is to duplicate the circuits involving the switched caps C1 and C2, creating two different sets for the two bandwidth modes, each with the same DC gain ratio of −C1/C2. This alternative embodiment ensures a seamless switching of time constants between input samples. During the switch, the state of the filter is retained on the feedback capacitors, CA.

The output threshold of the LPF 1101 and envelope sample output are compared using the switched capacitor track-and-latch comparator 1103 for a counter-based detection method. A CFAR detection method is implemented, where the detector threshold depends on average noise level. Envelope peaks that exceed the scaled noise reference are counted using the two counters 1104 and 1105 in order to determine the presence of a weak Barker preamble signal. The counters 1104 and 1105 are reset periodically in a staggered fashion to implement the equivalent of two overlapped detection windows.

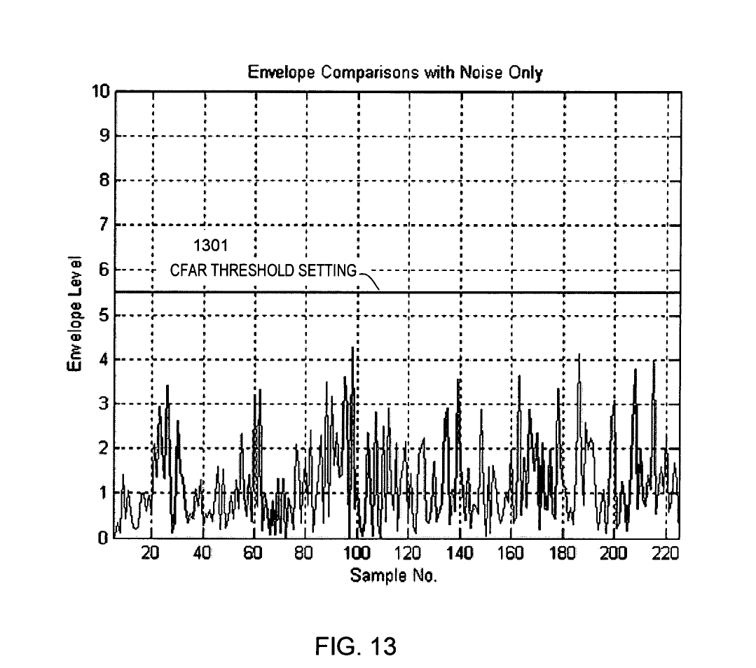

Operation of the counter-based Barker preamble detector can best be visualized by looking at the characteristics of the envelope samples in the presence of noise only compared with the case of a Barker signal present at 0 dB SNR. FIG. 13 is a graph diagram showing the noise only case relative to a typical CFAR threshold setting 1301. In this example, the probability of getting a threshold crossing is low, but increases as a function of time and/or of the total number of samples examined. The envelope samples are nearly independent since the baseband receive noise bandwidth is 0.8 times the Nyquist bandwidth of 11.0 megahertz (MHz). The graph diagram shows 220 samples, or equivalently a window of approximately 10 μs. Simulations show that with this threshold, the probability of getting 4 or more threshold crossings in the selected window is less than 1×10⁻⁶. Thus if a counter is set to detect signal with >=4 counts, the probability of false alarm on noise is less than 1×10⁻⁶, which is very low.

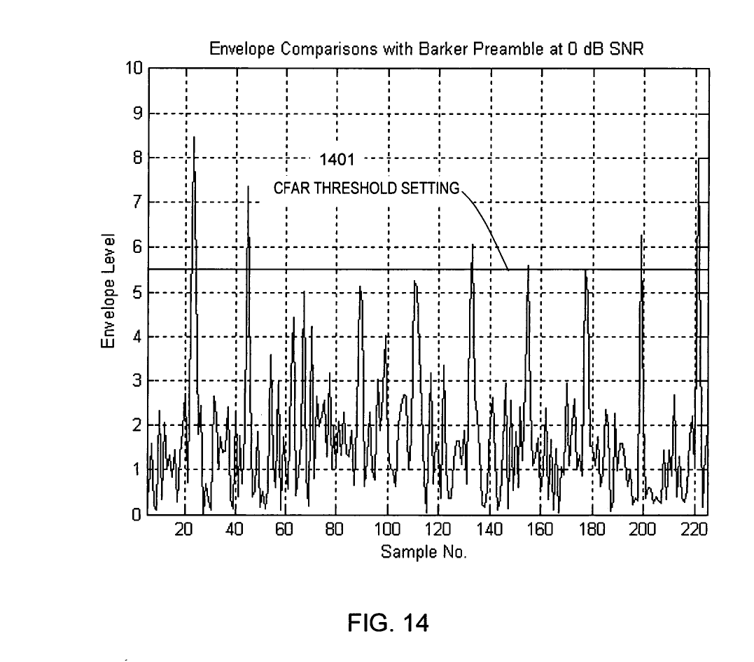

FIG. 14 is a graph diagram illustrating envelope comparisons when a weak Barker preamble is present with power equal to the noise (i.e. SNR=0 dB) relative to the CFAR threshold setting 1301. This condition corresponds to acceptable packet throughput for the 802.11b standard at nearly maximum range when there is no significant multipath distortion. In this case the Barker correlation peaks are evident and result in 7 threshold crossings in the selected window of approximately 10 μs. Without noise, a correlation peak at each symbol time or every 11 envelope samples is expected to be seen, equivalent to 10 peaks within the window. In this example, a count criteria of >=4 counts within the selected window yields reasonably reliable detection of the Barker signal. The use of the two overlapping counters 1104, 1105 whose outputs are logically OR'd together increases the detection probability further, with negligible consequence on the false alarm rate for noise only.

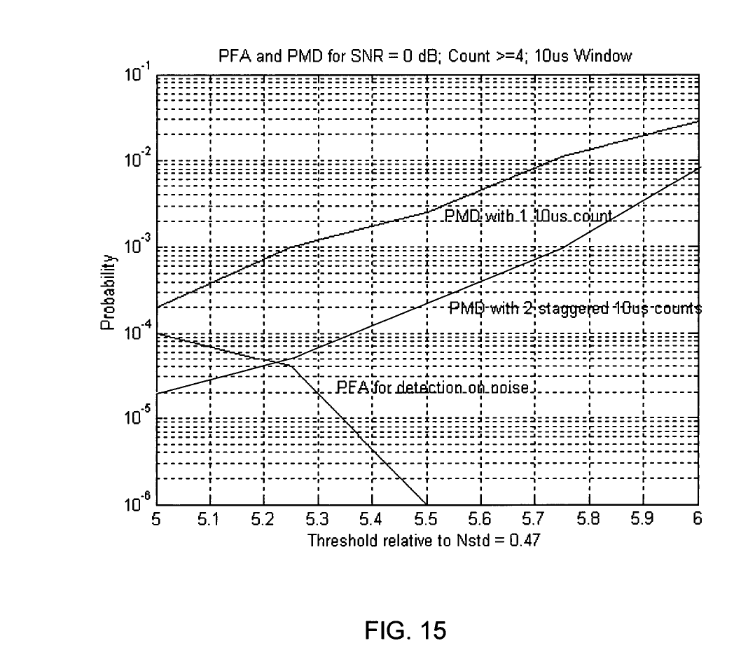

The graph diagrams of FIGS. 13 and 14 show that the detection and false alarm probabilities are very sensitive to the threshold level relative to signal level. That is the reason for forming the threshold dynamically from a direct scaling of the averaged envelope samples. Simulations have shown the ability to resolve the Barker preamble signal at 0 dB SNR with a two-counter configuration and 10 us window with Pfa of approximately 1.5×10⁻⁶ and Pmd of approximately 2.5×10⁻⁴. However, there are other considerations that may change the desired counting approach and parameters. FIG. 15 is a graph diagram showing the sensitivity of false alarm probability and missed detection probability with variations in the threshold value for this particular configuration with no multipath distortion.

The 802.11b preamble begins with a synchronization interval of either 128 1-bit symbols for the long preamble mode, or 56 1-bit symbols for the short preamble mode. The synchronization interval is followed by a start of frame delimiter (SFD) comprising 16 1-bit symbols that immediately precedes the header. The long or short mode preambles and SFD are modulated with DPSK at 1 Mbps (1 μs per symbol). Thus, in the short preamble mode, a 72 μs total timeline is allowed for all receiver preamble acquisition processing functions including onset detection, required for reliable header processing. Of this, roughly 19.2 μs are allocated for on-set detection, AGC lock, and DC lock.

The analog Barker detector 101 for detecting signal onset as described herein essentially performs the averaged high fidelity digital correlation detection function, but with AGC gain set to a fixed level appropriate for analog detection. The AGC function is not needed for initial detection, and can be powered down during the signal scan mode. When a weak Barker preamble is present or a large enough receive signal energy jump of any kind occurs, the analog SQ1 indicates detection, turning on power to the ADCs 103, digital interface 105, and baseband digital processing of the BBP/MAC 111. In one embodiment, Power-up occurs within 1 μs. Then the AGC locks on the new signal level in order to perform the carrier sense (CS as defined in the 802.11b standard), and continuous wave rejection threshold tests (CWND detection). When these tests have successfully been performed, the BBP/MAC 111 either shuts down again to the low power scan mode, or begins searching for the SFD. Upon onset detection, a timer is set to start the SFD timeout and again shuts down the BBP/MAC 111 if SFD is not found. If SFD is found, the transceiver 100 proceeds to demodulate and validate the header information.

In this simple overlapped counter implementation, signal onset detection takes up to 15 μs for weak signals, and less than 10 μs for strong signals. In the stronger signal case, the additional available time can be used for longer AGC acquisition and or diversity signal strength comparisons. At the cost of decreased detection Pfa and Pmd performance, the onset detection times with this scheme could be reduced from 5 to 15 μs to the range of 4 to 12 μs, if necessary.

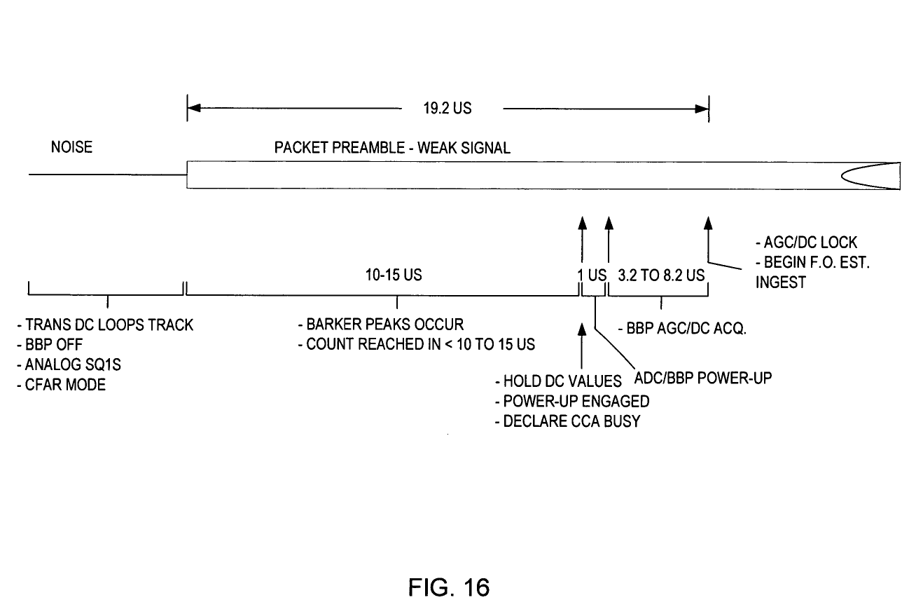

FIG. 16 is a timing diagram of the acquisition time line for a normal weak signal packet onset when the transceiver 100 is tracking at the noise floor. In this state, the ADCs 103 and the BBP/MAC 111 are assumed to be “off” or in low-power mode and the analog Barker detector 101 is utilized for signal onset detection with a CFAR threshold.

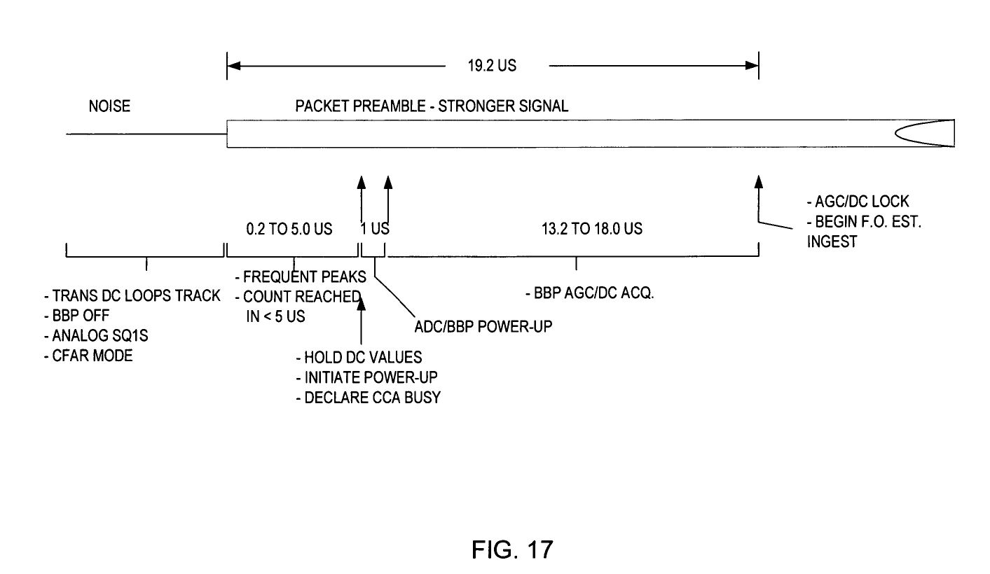

FIG. 17 is a timing diagram of the acquisition time line for the strong signal case. With stronger signal levels, CFAR threshold crossings occur much more often at onset because the threshold has not had enough time to adapt. In addition, correlation peaks are almost always detected and at least one crossing occurs each symbol time (every 1 μs). The count is typically reached within 5 μs, allowing more time for BBP AGC/DC acquisition.

Versions with improved detection processing are now described. The simple sample-by-sample threshold comparison and counting scheme described above has somewhat degraded Pmd performance when multi-path signals are present. Intuitively, this occurs because the received multi-path signal power can be spread out over a range of delay times, and destructive multi-path interference can reduce the Barker matched filter peak levels at the main correlation peak times.

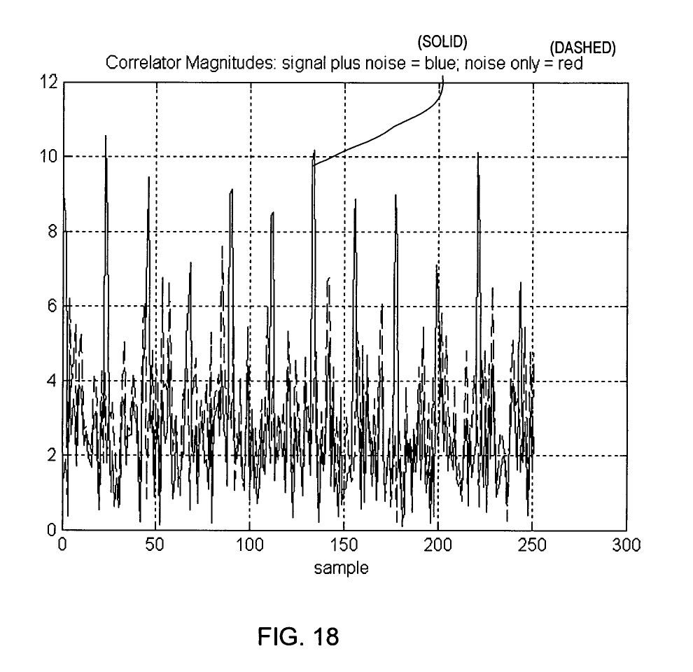

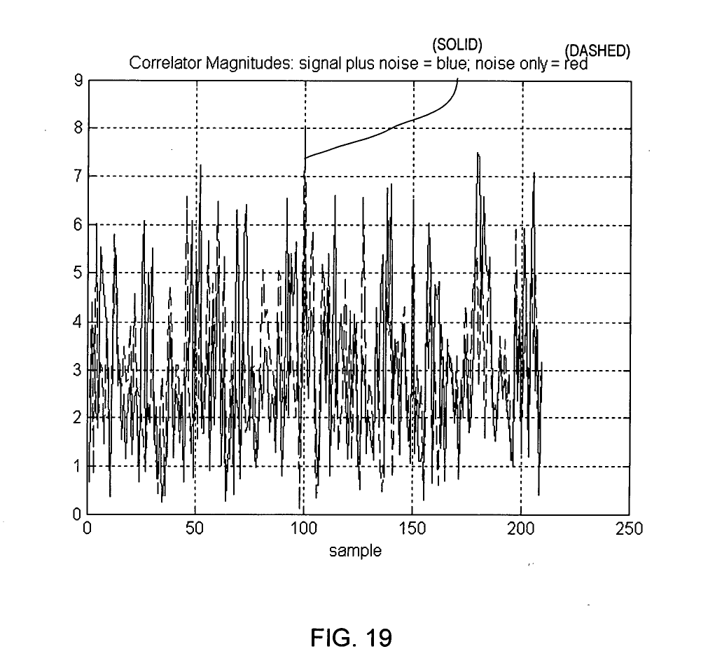

FIGS. 18 and 19 show time domain correlator magnitude waveforms for a case where the root-mean square (RMS) delay spread is 250 ns and SNR=0 dB (FIG. 19) compared to the same SNR with no multipath (FIG. 18). For each graph, the signal plus noise is shown using solid lines and the noise only is shown with dashed lines. With severe multi-path as shown in FIG. 19, the Barker correlation peaks are difficult to separate from the noise peaks using simple threshold counting.

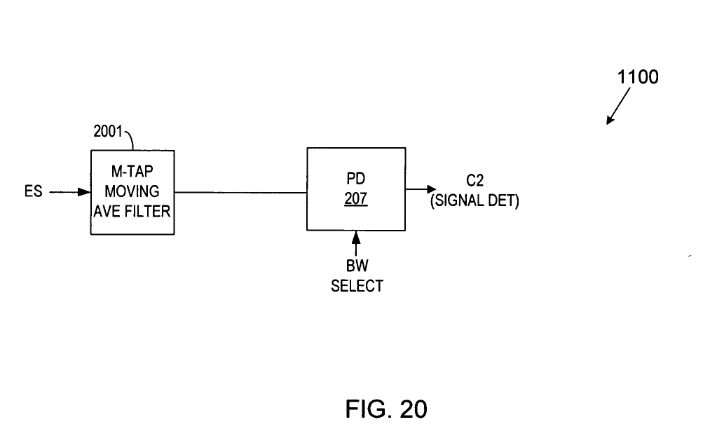

The SNR into the threshold comparator may be improved by further filtering after the Barker-correlation envelope detection. The post-detection filtering should be roughly matched to the time spread in signal power with multi-path signals present. Simulation shows that a three sample moving average filter (where the sampling interval is approximately 45.5 ns) is a good match for threshold detection of signals with up to 150 ns RMS delay spread. FIG. 20 is a block diagram illustrating a three sample moving average FIR filter 2001 coupled at the output of the envelope detector 205 for receiving the ES signals and providing ES′ signals to the PD 207.

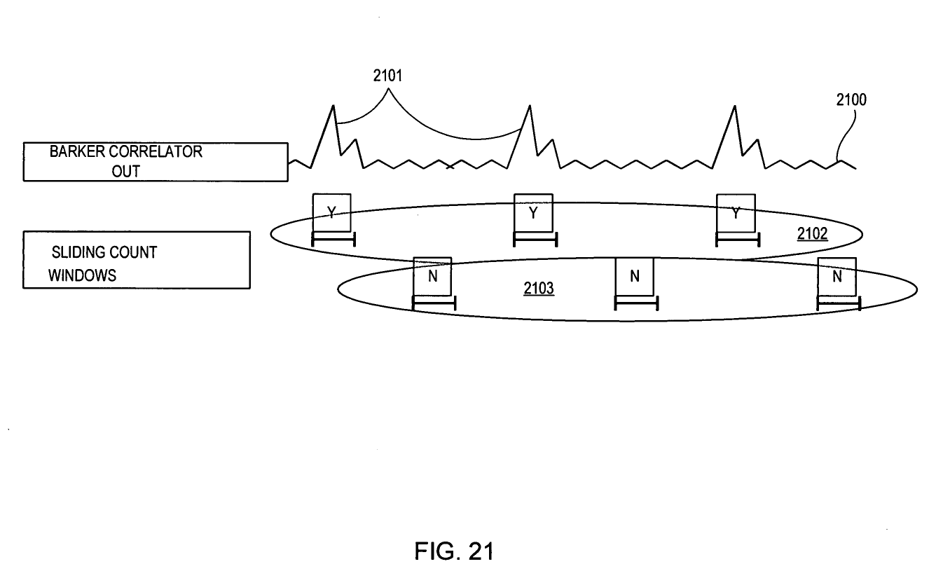

As already noted, multi-path distortion tends to spread the correlation peak energy locally around the Barker peak epochs. However, the correlation epochs are periodic and detection algorithms can use this property to improve performance. FIG. 21 is a figurative diagram illustrating sliding window peak counting. The Barker correlator output is shown in graphic form at 2100 with periodic Barker peak epochs 2101. A first set of sliding count windows is shown at 2102 and a second set is shown at 2103. The set of sliding count windows 2102 are generally coincident with the epochs 2101 from the Barker correlator indicating detection. Since the low-power analog Barker detector produces a quantized binary output, the overall detection performance may be improved by counting exceeded threshold events only around the anticipated Barker peak epochs. This has minimal effect on peak counts with Barker signal present, but reduces the probability of false alarm counts on noise.

Improved counting algorithms are implemented with parallel “enabled” counter banks instead of the simple overlapped counters 1104, 1105 shown in FIG. 11. For example, if the count window is set for 4 samples and the counters are overlapped, a bank of 11 staggered counters can be used in each overlapped group. Overall, a relatively small amount of added logic gate count is required to implement the counters, enabling logic, decision logic, and reset logic.

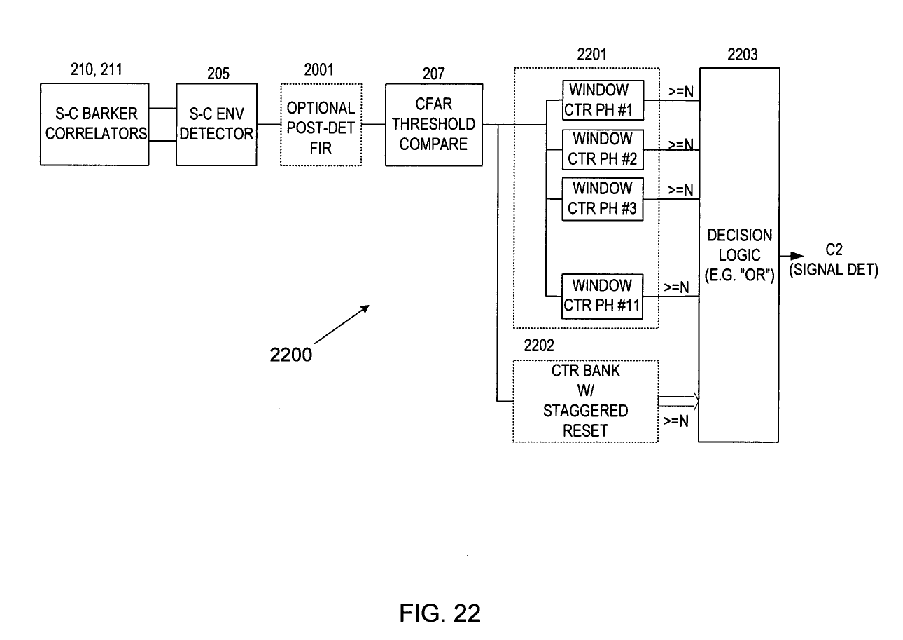

FIG. 22 is a block diagram of an exemplary embodiment of an analog Barker detector 2200 which may be used as to implement the analog Barker detector 101, where the detector 2200 includes a counter circuit 2210 employing a sliding window counting algorithm. The Barker matched filters 210, 211, the envelope detector 205, the optional post-detection FIR filter 2001 and the peak detector 207 are shown generating the SD signal provided to the counter circuit 2210. The counter circuit 2210 includes a pair of counter banks 2201 and 2202 with staggered resets. Further details of the counter bank 2201 are shown, where it is understood that the counter bank 2202 is implemented in a similar manner. Each counter bank 2201, 2202 includes 11 window counters 2203, each providing outputs to decision logic (e.g., “OR” logic or the like) 2204, which develops a portion of the C2 signals. Each output is asserted when a corresponding count reaches or exceeds a predetermined count value N (or >=N). In this approach, there are two blocks of overlapped window counters that are reset after a detection interval of 8 to 10 μs. Resets to the two blocks are staggered by roughly half the detection interval (4 to 5 μs) in order to reduce the detection time from preamble onset. Each window counter is enabled to count for 4 sample periods in each Barker interval over the 8 to 10 total Barker periods. The window counters 2203 are phased with a two-sample overlap. When a Barker preamble is present, the window counter 203 that best aligns with the (possibly spread) correlation peaks experiences a substantially higher total count (up to 3 counts per enabled interval). The counts are compared with a relatively high threshold in order to circumvent false alarms on noise. The window counter outputs are combined using the decision logic 2204 (e.g., OR'd together) in order to detect the maximum correlation count.

The improved counting algorithms may be used either with or without analog post envelope-detection filtering ahead of the threshold comparator. There is a tradeoff of post envelope-detection algorithm complexity and performance.

Although the present invention has been described in considerable detail with reference to certain preferred versions thereof, other versions and variations are possible and contemplated. Those skilled in the art should appreciate that they can readily use the disclosed conception and specific embodiments as a basis for designing or modifying other structures for providing out the same purposes of the present invention without departing from the spirit and scope of the invention as defined by the appended claims.

1. A receiver including an analog Barker detector, comprising:
digital processing logic having a receive signal input for processing digital baseband signals and having a power activation input for receiving a detection signal;
a radio that receives and converts radio frequency (RF) signals into analog baseband signals, said radio comprising:
a Barker matched filter coupled to receive said analog baseband signals;
an envelope detector, coupled to said Barker matched filter;
a peak detector, coupled to said envelope detector; and
a counter circuit, coupled to said peak detector, that detects Barker signals and that provides said detection signal; and
an analog-to-digital converter (ADC) that converts said analog baseband signals into said digital baseband signals.

2. The receiver of claim 1, wherein said digital processing logic is powered down between signal acquisitions and powers up in response to said detection signal.

3. The receiver of claim 1, wherein said ADC includes a power activation input receiving said detection signal and is powered down between signal acquisitions and powers up in response to said detection signal.

4. The receiver of claim 1, wherein said radio performs direct conversion and further includes first order DC correction loops using up/down counters as feedback integrators.

5. The receiver of claim 1, wherein said Barker matched filter comprises:
a track and hold stage having an input receiving said analog baseband signals and an output; and
a Barker correlator having an input coupled to said output of said track and hold stage and an output coupled to said envelope detector.

6. The receiver of claim 5, wherein said track and hold stage comprises:
a sample circuit that samples said analog baseband signals and that provides corresponding voltage samples;
a converter that converts each voltage sample to a sample current; and
a plurality of matched current generator stages, coupled to said converter, that converts each said sample current into a plurality of matched AC currents.

7. The receiver of claim 6, wherein each of said plurality of matched current generator stages comprises a current mirror and a slaved current source.

8. The receiver of claim 6, wherein a first of said plurality of matched current generator stages is coupled to a DC offset loop.

9. The receiver of claim 5, wherein said Barker correlator comprises:
a plurality of analog multiply-accumulate (MAC) cells, coupled to said track and hold stage, that collectively performs parallel Barker matched filtering in overlapped filter windows; and
a switched-capacitor (S-C) charge summer and reset circuit having an input coupled to said Barker correlator and an output coupled to said envelope detector.

10. The receiver of claim 9, wherein each of said plurality of analog MAC cells comprises a plurality of capacitors and switches that accumulate weighted current samples over a predetermined filter cycle.

11. The receiver of claim 1, wherein said envelope detector comprises:
a plurality of track and latch comparators;
decode logic coupled to said plurality of track and latch comparators; and
a switched-capacitor charge redistribution summing amplifier coupled to said decode logic.

12. The receiver of claim 1, wherein said peak detector averages Barker correlator filter output samples, derives a dynamic threshold value, and compares said dynamic threshold value with Barker correlator filter output samples.

13. The receiver of claim 1, wherein said peak detector comprises:
a low pass filter (LPF) that averages envelope output samples and that provides a threshold signal; and
a comparator that compares said threshold signal with said envelope output samples.

14. The receiver of claim 13, wherein said LPF incorporates selectable bandwidth and is initially set in a high bandwidth mode during initial acquisition and re-acquisition of noise floor, and is switched to a low bandwidth mode for tracking and signal detection.

15. The receiver of claim 14, wherein said LPF further incorporates a quench mode during which a previously unknown signal state is erased and re-initialized to an expected noise floor value.

16. The receiver of claim 13, further comprising a multiple tap moving average FIR filter coupled between said envelope detector and said peak detector.

17. The receiver of claim 1, wherein said counter circuit comprises two counters that are each reset periodically in a staggered fashion for overlapping windows and an OR circuit coupled to outputs of said two counters.

18. The receiver of claim 1, wherein said counter circuit comprises:
a plurality of overlapped window counters coupled in parallel and having a plurality of outputs; and
decision logic coupled to said plurality of outputs of said plurality of overlapped window counters.

19. The receiver of claim 18, wherein said plurality of overlapped window counters are organized into a pair of parallel enabled banks, each bank comprising a plurality of staggered counters, and each bank reset by approximately half a predetermined detection interval.

20. The analog Barker detector of claim 18, wherein said decision logic comprises OR logic.
